(19) United States
(12) Patent Application Publication
(10) Pub. No.: US 2025/0375930 A1
(43) Pub. Date: Dec. 11, 2025

(54) SYSTEM FOR THE PRODUCTION OF PLASTIC PRODUCTS

(71) Applicant: SACMI IMOLA S.C., Imola (IT)

(72) Inventors: Marco SALIERI, Imola (IT); Gabriele SANGIORGI, Faenza (IT); Marco PROSPERI, Bagnara Di Romagna (IT); Lorenzo MIMMI, Imola (IT)

(21) Appl. No.: 18/876,034

(22) PCT Filed: Jun. 14, 2023
(86) PCT No.: PCT/IB2023/056140

§ 371 Date: Dec. 17, 2024

(30) Foreign Application Priority Data
Jun. 17, 2022 (IT) 102022000012836

(51) Int. Cl. B29C 45/76; B29C 45/17; B29L 31/00

(52) U.S. Cl. CPC B29C 45/766; B29C 45/1742; B29C 2945/76167; B29C 2945/76254; B29C 2945/76434; B29L 2031/712

(57) ABSTRACT

A system for the production of plastic products, which includes a molding apparatus including a first half-mold and a second half-mold both of which can move on command with respect to each other, and a reading device, a control device and storage elements being functionally connected to the control device. The first half-mold and the second half-mold are associated with at least one respective marker, the markers being readable by the reading device and having at least one respective identification code, the respective identification code corresponding to a record comprised in the storage elements, the control device-being configured to check at least the compatibility between the first half-mold and the second half-mold on the basis of combinations of records comprised in the storage elements.

### CROSS-REFERENCE TO RELATED APPLICATIONS

This application is a 35 U.S.C. § 371 National Stage patent application of PCT/IB2023/056140, filed on 14 Jun. 2023, which claims the benefit of Italian patent application no. 102022000012836, filed on 17 Jun. 2022, the disclosures of which are incorporated herein by reference in their entirety.

### TECHNICAL FIELD

The present disclosure relates to a system for the production of plastic products, for example preforms for the production of plastic containers.

### BACKGROUND

Devices for molding plastic products, for example preforms, are known, which are associated with unloading and storage devices, which are normally constituted by a cooling plate which defines a plurality of accommodations arranged in an array and designed to accommodate respective still-hot preforms for the time required to cool them at least partially.

Typically, such preforms are fed directly from the injection press to the cooling plate and remain in the respective accommodation for a preset time.

Specifically, once the injection process has ended, meaning the stage in which the male and female mold parts remain in the closed position, the mold is opened and the preforms are moved to the cooling plate so that the accommodations of the cooling plate can engage with the respective portions of preforms that emerge from the mold part and are extracted from it, so as to allow the mold to be closed and a new molding cycle to be performed.

The unloading of the preforms from the cooling plate occurs after an expulsion action which can be obtained with pneumatic means, mechanical means, or a combination thereof.

Devices for injection molding of preforms, and in particular of the preforms used to make plastic containers, are constituted by a first portion associated with a plurality of cavities, or female mold parts, and by a second portion which supports respective male plugs, or male mold parts.

To produce a preform, the male plugs are inserted in the respective cavities. In the mold, the cavity and the male plug are configured and arranged so that, after the male plug of the mold has been inserted in the cavity, an interspace is formed between the internal surface of the cavity and the surface of the male plug, the shape of which corresponds to the shape of the preform that it is desired to obtain.

The interspace is delimited externally by the cavity and internally by the male plug of the mold.

In order to obtain the preform, polymer in the liquid state, typically PET, is injected at high pressure into the interspace between the cavity and the male plug.

As soon as the molten mass has cooled sufficiently and therefore has solidified sufficiently, the mold is opened and the solidified molten mass is removed from the cavity as a preform.

The molds and the associated format parts have very complex geometries that have an impact on the setup times.

In fact, the operator, with every change of format, has to manually enter a great deal of data relating to the type of preform in production and relating to the corresponding movements (strokes) of the various parts of the machine.

These operations are further complicated by the fact that in many cases the operator intervenes on the machine to change only a few parts, for example the mold, but not the entire mold, in order to produce similar preforms, for example having the same body but different necks.

The production of similar preforms is furthermore associated with one or more “recipes” which need to be correctly identified and selected by the operator.

The term “recipe” means the set of machine settings that can be obtained and optionally programmed using its interface, and which are necessary in order to obtain the technological parameters adapted to the production of a given preform.

### SUMMARY

The aim of the present disclosure is to eliminate, or at least to drastically reduce, the above-mentioned drawbacks.

Within this aim, the disclosure provides a system for the production of plastic products, which makes it possible to manage the format change operations in an extremely practical manner.

The disclosure further makes available a system for the production of plastic products that makes it possible to optimally manage the choice of recipes as a function of the products to be molded and of the configuration of the mold.

This aim and these and other advantages which will become better apparent hereinafter are achieved by providing a system for the production of plastic products according to the disclosure herein.

### BRIEF DESCRIPTION OF THE DRAWINGS

Further characteristics and advantages of the disclosure will become more apparent from the description of some preferred, but not exclusive, embodiments of a system for the production of plastic products according to the disclosure, which are illustrated by way of non-limiting example in the accompanying drawings, wherein:

FIG. 1 is a schematic view of the system according to the disclosure;

FIG. 2 is a schematic exploded view of the various components of the system according to the disclosure;

FIG. 3 is a schematic view of the various components of the system with the corresponding markers in a first operative active condition;

FIG. 3a is a diagram of the information managed by the system in the first operative active condition;

FIG. 3b is a side view of the product made by the system in the first active condition;

FIG. 4 is a schematic view of the various components of the system with the corresponding markers in a second operative active condition;

FIG. 4a is a diagram of the information managed by the system in the second operative active condition; and

FIG. 4b is a side view of the product made by the system in the second active condition.

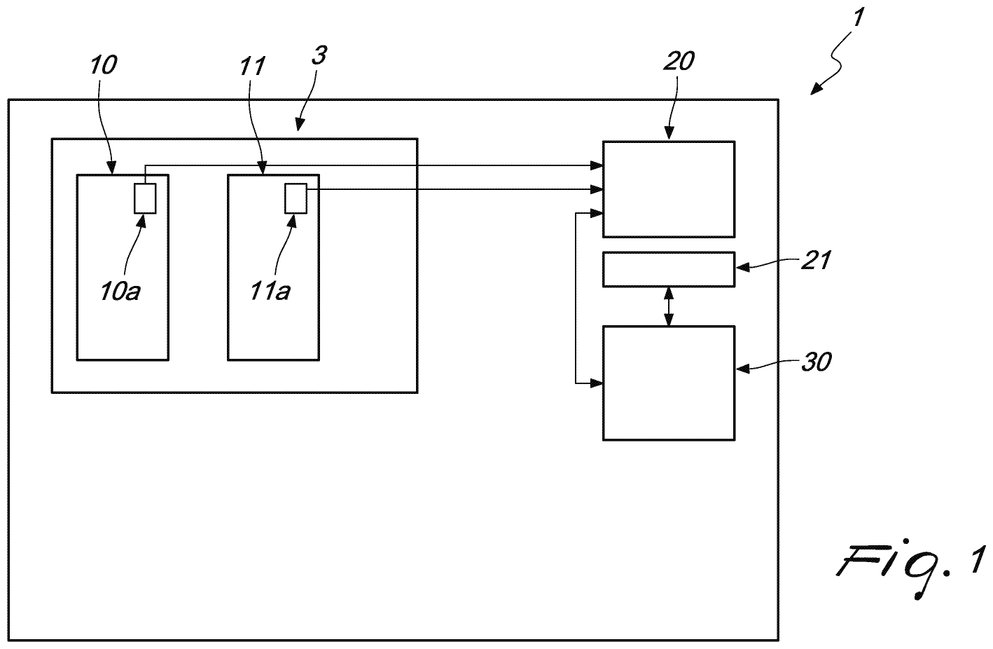

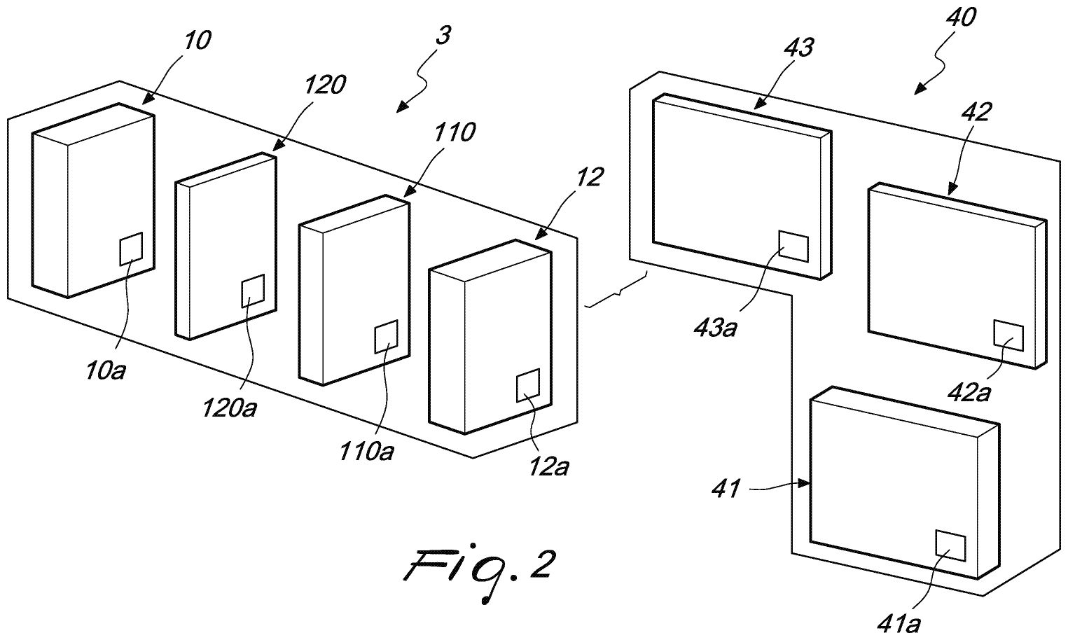

### DETAILED DESCRIPTION OF THE DRAWINGS

With reference to the figures, a system for the production of plastic products, generally designated by the reference numeral 1, comprises a molding apparatus 3 comprising a mold constituted by a first half-mold 10 and a second half-mold 11 both of which can move on command with respect to each other between a mold-closed position, in which at least one molding void is defined which has a shape that corresponds to the product to be molded, and a mold-open position, in which the removal of the product molded by the molding apparatus 3 is allowed.

The system 1 further comprises a reading device 20, a control device 30 and storage means 21.

The reading device 20 and the storage means 21 are functionally connected to the control device 30.

The first half-mold 10 and the second half-mold 11 are associated with at least one respective marker 10a, 11a.

The markers 10a, 11a are readable by the reading device 20 and comprise at least one respective identification code.

The respective identification code corresponds to a record comprised in the storage means 21.

In particular, the control device 30 is configured to check at least the compatibility between the first half-mold 10 and the second half-mold 11 on the basis of combinations of records comprised in the storage means 21.

The storage means 21 can comprise a centralized memory or they can be distributed, at least partially, within each marker 10a, 11a.

Advantageously, the control device 30 is further configured to produce at least one operating configuration of the molding apparatus 3 on the basis of the combinations of records that correspond to the identification codes of the respective markers 10a, 11a of the first half-mold 10 and of the second half-mold 11.

According to a preferred embodiment, the molded product comprises a preform 200.

With reference to the embodiment shown in the figures, the first half-mold 10 comprises a first plate 100 which supports a plurality of male plugs 101 and the second half-mold comprises a second plate 110 which defines a plurality of cavities and a third plate 120 which comprises a plurality of elements, commonly called “neck rings” in the jargon, which can be moved mutually closer and further apart in order to define the mouth of the preform.

In particular, the second half-mold comprises a plurality of matrices intended to define respective cavities. The matrices are provided in two bodies: a first body, carried by the third plate 120, is intended to provide the mouth of the preform and is made of two “neck rings” which can be moved mutually closer and further apart, and a second body, generally monolithic, is supported by the second plate 110 and is intended to define the substantially cylindrical part of the cavity and its bottom wall.

The first and the second half-mold 10, 11 can move on command with respect to each other between a mold-closed position, in which at least one male plug is arranged with one of its forming longitudinal ends, inside a respective cavity in order to define a molding void which has a shape that corresponds to the preform to be molded, and a mold-open position, in which 25 the male plug is arranged outside the respective cavity so as to allow the removal of the molded preform from the device.

The molding apparatus 3 further comprises an injection device 12, which is configured to send the liquid plastic to the first half-mold 10 and to the second half-mold 11.

The injection device 12 is also associated with at least one respective marker 12a which can be read by the reading device 20.

The system 1 for the production of plastic products further comprises an unloading and cooling apparatus 40 which is functionally associated with the molding apparatus 3.

According to a possible practical embodiment, the unloading and cooling apparatus 40 comprises a takeout plate 41, a cooling plate 42 and a gripper plate 43.

The takeout plate 41, the cooling plate 42 and the gripper plate 43 are associated with at least one respective marker 41a, 42a, 43a which can be read by the reading device 20.

The system 1 for the production of plastic products further comprises a supporting structure 2 which is adapted to support, and keep mutually in position, the molding apparatus 3 and the reading device 20.

The supporting structure 2 is further adapted to support, and keep in position, the control device 30 and the remote storage means 21.

The control device 30 and/or the storage means 21 can be both associated with and supported by the supporting structure 2, and therefore close to the molding apparatus 3 and to the reading device 20, and they can also be outside the supporting structure 2, and therefore spaced apart (for example beside it, with a wired connection, or remote, with a connection over a telematics communication network) from the molding apparatus 3 and from the reading device 20.

The use of the system 1 according to the disclosure is the following.

The various components that make up the system 1, for example the first plate 100, the second plate 110, the third plate 120, the injection device 12, the takeout plate 41, the cooling plate 42 and the gripper plate 43, are fixed to the supporting structure during the step of setting up the system.

Each one, and more generally at least two, of the above mentioned components are associated with a respective marker that can be read by the reading device 20.

Each individual marker 100a, 110a, 120a, 12a, 41a, 42a, 43a comprises at least one respective identification code that corresponds to a record comprised in the storage means 21, which can be associated with the respective marker or contained in a storage memory.

For the purposes of example, the records associated with the identification code can contain the following information:
serial number;
number of cavities and pitch;
volume of the portion of preform corresponding to the individual component;
dimensions of the portions of each component, necessary to define the various “recipes” and the position of the movement axes;
length of the preform portions corresponding to the individual component;
diameter of the preform body.

The term “recipe” means the set of settings of the system 1 that can be obtained and optionally programmed using its interface or the control system 30, and which are necessary in order to obtain the technological parameters adapted to the production of a given preform.

The control device 30, which is functionally connected with the storage means 21, is configured to check at least the compatibility between all the components provided with a respective marker 20 on the basis of combinations of records comprised in the storage means 21.

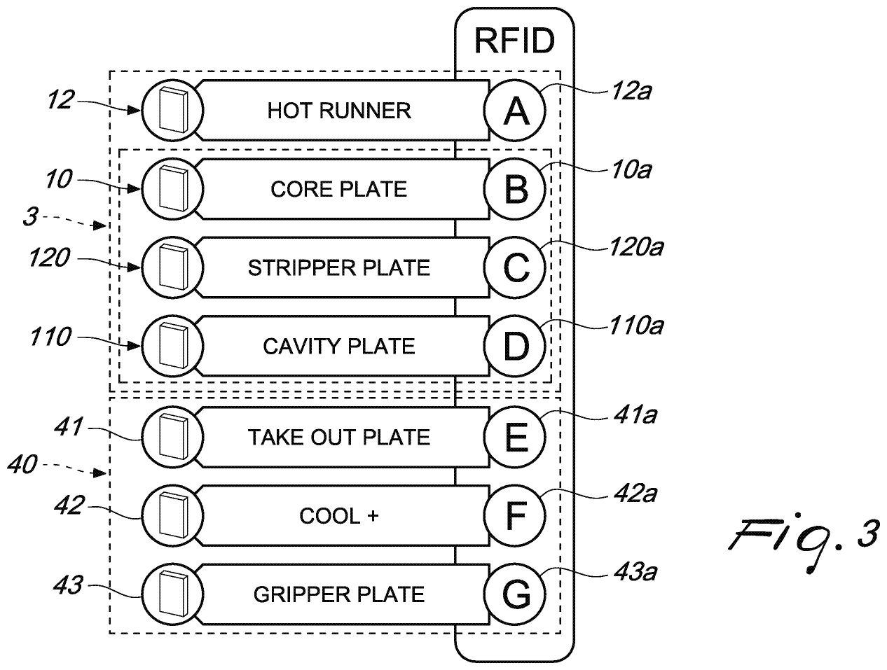

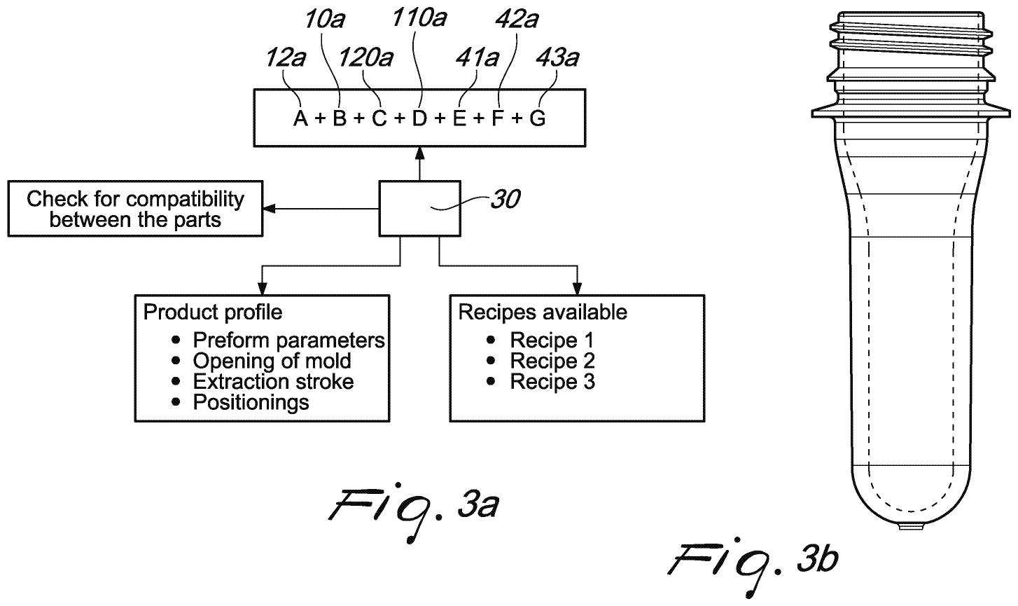

Specifically, with reference to what is shown in FIGS. 3, 3a and 3b, the control device 30 retrieves the records corresponding to the markers 100a, 110a, 120a, 12a, 41a, 42a, 43a and verifies the compatibility between the respective components on the basis of combinations of records comprised in the storage means 21.

Simultaneously, as shown schematically in FIG. 3a, the control device 30 supplies a profile for the product being molded which comprises, for example, the following data (which can be obtained from the records received):
parameters of the preform;
parameters for opening the mold;
data relating to the extraction stroke;
positionings.

Furthermore, the control device 30 provides the possible “recipes” associated with that configuration of the system (in the case shown in FIG. 3a, the recipes 7, 8 and 9).

If the operator needs to intervene on the system 1 because it is necessary to use the molding apparatus 3 to provide a different preform, and specifically one that has the same preform body but a different neck, then the operator will substitute the third plate 120, which this time will be associated with a marker 120a′.

Once the molding apparatus 3 is reassembled, the reading device or devices 20 will then read the identification code of each component of the system.

The control device 30 at this point checks that the record associated with the new marker 120a′ is also compatible with all the other records for the other components, which remain unchanged.

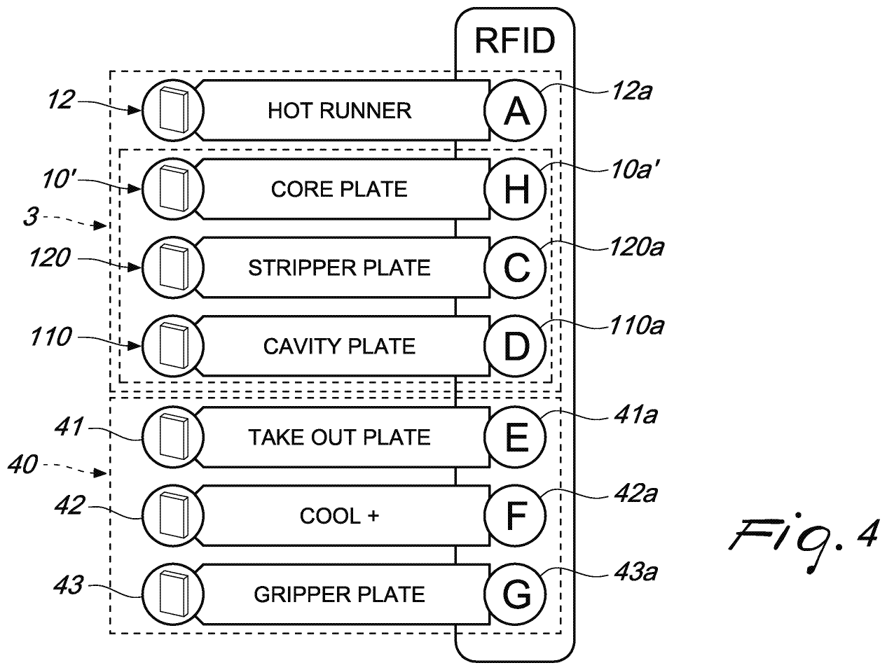

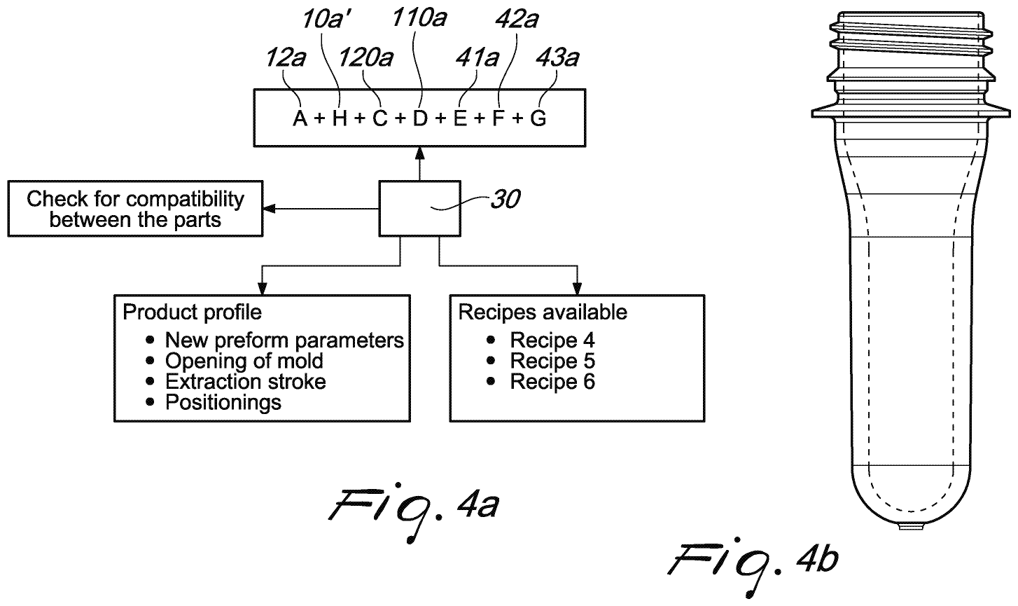

Simultaneously, as shown schematically in FIG. 4a, the control device 30 supplies a profile for the new product being molded which comprises, for example, the following data (which can be obtained from the records received):
parameters of the preform;
parameters for opening the mold;
data relating to the extraction stroke;
positionings.

Furthermore, the control device 30 provides the possible “recipes” associated with that configuration of the system (in the case shown in FIG. 4a, the recipes 4, 5 and 6.

In practice it has been found that the disclosure fully achieves the intended aim and objects, by providing a system for molding plastic products that is capable of reducing setup times during interventions on the various components of the mold, in particular during changes of format.

The solution proposed further makes it possible to drastically reduce operator interventions, and consequently the risks of error, in setting up the apparatus.

The system further makes it possible to display, in a simple and rapid manner, the recipes available for the product being molded.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1.-7. (canceled)

8. A system for the production of plastic products, which comprises a molding apparatus comprising a mold constituted by a first half-mold and a second half-mold both of which are configured to move on command with respect to each other between a mold-closed position, in which at least one molding void is defined which has a shape that corresponds to a product to be molded, and a mold-open position, in which a removal of the product molded by said molding apparatus is allowed, wherein said system further comprises a reading device, a control device and storage means, said reading device and said storage means being functionally connected to said control device, and wherein said first half-mold and said second half-mold are associated with at least one respective marker, said markers being readable by said reading device and comprising at least one respective identification code, said respective identification code corresponding to a record comprised in said storage means, said control device being configured to check at least a compatibility between said first half-mold and said second half-mold on the basis of combinations of records comprised in said storage means, said control device being further configured to determine at least one operating configuration of said molding apparatus on the basis of said combinations of records that correspond to said identification codes of said respective markers of said first half-mold and said second half-mold, said control device being configured to supply “recipes” associated with said at least one operating configuration.

9. The system for the production of plastic products according to claim 8, wherein said molded product comprises a preform.

10. The system for the production of plastic products according to claim 9, wherein said first half-mold comprises a first plate which supports a plurality of male plugs and said second half-mold comprises a second plate which defines a plurality of cavities and a third plate which comprises a plurality of neck rings which are configured to be moved mutually closer and further apart in order to define a mouth of said preform.

11. The system for the production of plastic products according to claim 8, wherein said molding apparatus comprises an injection device which is configured to send liquid plastic to said first and said second half-mold, said injection device being associated with at least one respective marker which is readable by said reading device.

12. The system for the production of plastic products according to claim 8, further comprising an unloading and cooling apparatus which is functionally associated with said molding apparatus, said unloading and cooling apparatus comprising a takeout plate, a cooling plate and a gripper plate, each one of said takeout plate, said cooling plate and said gripper plate being associated with at least one respective marker which is readable by said reading device.

13. The system for the production of plastic products according to claim 8, further comprising a supporting structure which is adapted to support and keep mutually in position said molding apparatus and said reading device.

14. The system for the production of plastic products according to claim 13, wherein said supporting structure is further adapted to support and keep in position said control device and said storage means.
